(19) United States
(12) Patent Application Publication
(10) Pub. No.: US 2006/0126518 A1
(43) Pub. Date: Jun. 15, 2006

(54) Apparatus and method for securing internet server

(76) Inventors: Seungmin Lee, Daejeon-city (KR); Taek Yong Nam, Daejeon-city (KR); Jong Soo Jang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/085,893

(22) Filed: Mar. 21, 2005

(30) Foreign Application Priority Data
Nov. 25, 2004 (KR) 10-2004-0097471

(51) Int. Cl. H04J 1/16; H04L 12/56

(52) U.S. Cl. 370/244; 370/389

(57) ABSTRACT

Provided are an apparatus and a method for securing internet server, including: a conformance determiner which determines whether or not packets received from a network are normal, and outputs a determination result; a rate limiter which classifies packets according to predetermined rates, and limits bandwidth; and a server global information base which contains basic information including user information and site information, and is used to determine whether or not a packet is normal, and provides basic information to the conformance determiner and the rate limiter. The apparatus and the method for securing the internet server, that are applied to a main server that provides internet service, by preventing external attacks, intrusion, or vulnerability before the internet server fails, and continuously providing normal internet service through prompt recovery when the internet server fails, in order to guarantee reliable internet service.

This application claims the priority of Korean Patent Application No. 10-2004-0097471, filed on Nov. 25, 2004, in the Korean Intellectual Property Office, the disclosure of which is incorporated herein in its entirety by reference.

### BACKGROUND OF THE INVENTION

1. Field of the Invention

The present invention relates to an apparatus and a method for securing an internet server to prevent its failure, and recover it to provide normal internet service in case of failure, and more particularly, to an apparatus and a method for securing an internet server that guarantee reliable internet service by classifying internet service users and limiting bandwidth allocated to the service during both internet server failure and normal function.

2. Description of the Related Art

In the conventional art, an intrusion detection system is placed in front of a server to detect an external attack or intrusion before it can cause the internet server to fail. The conventional art does not normally provide internet service while an internet server recovers from failure.

It is necessary to remove causes of failure by checking basic packets when the internet server functions normally, and to provide normal internet service by recovering the internet server and analyzing packet flow when the internet server fails.

### SUMMARY OF THE INVENTION

The present invention provides an apparatus and a method for securing an internet server, that are applied to a main server that provides internet service, by preventing external attacks, intrusion, or vulnerability before the internet server fails, and continuously providing normal internet service through prompt recovery when the internet server does fail, in order to guarantee reliable internet service.

According to an aspect of the present invention, there is provided a apparatus for securing an internet server, comprising: a conformance determiner which determines whether or not packets received from a network are normal, and outputs a determination result; a rate limiter which classifies packets according to predetermined rates, and limits bandwidth; and a server global information base which contains basic information including user information and site information, and is used to determine whether or not a packet is normal, and provides basic information to the conformance determiner and the rate limiter.

According to another aspect of the present invention, there is provided a method of securing an internet server, comprising: preparing basic information including user information and site information used to determine whether or not a packet is normal; receiving packets from a network, and determining whether or not the packets are normal; and classifying the packets according to rates, and limiting bandwidth according to the rates.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating an apparatus for securing an internet server according to an embodiment of the present invention;

FIG. 2 is a flow chart of a method of securing an internet server according to an embodiment of the present invention; and

FIG. 3 is a diagram of an internet service provider (ISP) to which the method of securing the internet server is applied according to an embodiment of the present invention.

### DETAILED DESCRIPTION OF THE INVENTION

The present invention will now be described more fully with reference to the accompanying drawings.

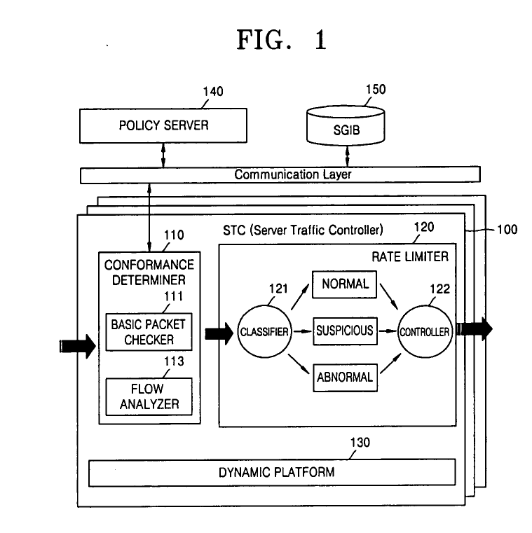

FIG. 1 is a block diagram illustrating an apparatus for securing an internet server according to an embodiment of the present invention. Referring to FIG. 1, a server traffic controller (STC) 100 comprises a conformance determiner 110 that determines whether or not packets received from a network are normal and outputs a determination result, and a rate limiter 120 that classifies packets according to predetermined rates and limits bandwidth allocated to the packes.

The conformance determiner 110 comprises a basic packet checker 111 that checks whether or not packets are normal based on user information and site information when the internet server functions normally, and a flow analyzer 113 that passes normal packets and catches causes of failure by analyzing the flow of abnormal packets when the internet server fails.

The rate limiter 120 comprises a classifier 121 that classifies packets passing in the basic packet checker 111 and the flow analyzer 113 according to rates, and a controller 122 that controls the bandwidth allocated to the packes.

A dynamic platform 130 included in the STC 100 allows new functions and policies of an external device such as a policy server 140 to be dynamically applied to the internet server while the internet server operates.

A server global information base 150 which is separate from the STC 100 has detailed user information including black and white lists relating to users' IP addresses and user variation per time period, and continuously updates detailed user information using the basic packet checker 111 and the flow analyzer 113.

The STC 100 may be embedded in a server system, or may be a separate system.

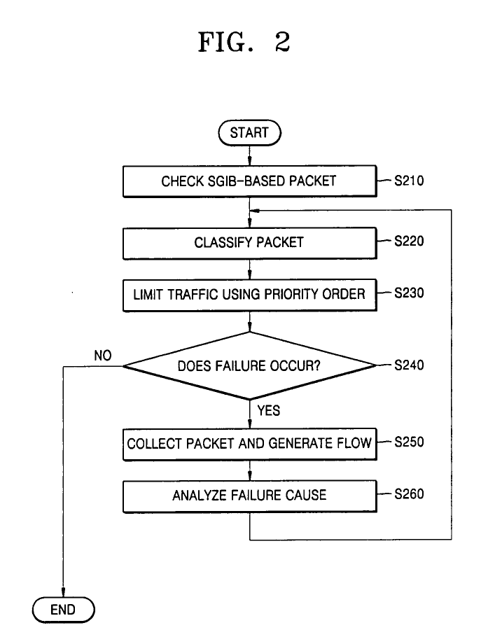

FIG. 2 is a flow chart of a method of securing an internet server according to an embodiment of the present invention. Referring to FIG. 2, the server global information base 150 has a database of detailed user information including black and white lists relating to the users' IP addresses and user variation per time period.

In Operation S210, it is determined whether or not a packet received from the network is normal based on user information and site information that are stored in the server global information base 150.

In Operation S220, packets are classified to rates according to the determination in Operation S210, and analysis information is created.

In Operation S230, received packets are classified based on a bandwidth policy that designates a packet rate to limit traffic bandwidth using the priority order.

In Operation S240, when the internet server fails, in Operation S250, received packets are collected to generate a packet flow. The packet flow is used to analyze an intrusion and attack pattern by collecting related packets and creating combined information of packet flow. In Operation S260, the packet flow catches a packet that causes the internet server failure based on information included in the server global information base 150 and information analyzed in the STC 100 Therefore, normal internet service is provided by limiting packet traffic during or after the intrusion and attack pattern are analyzed.

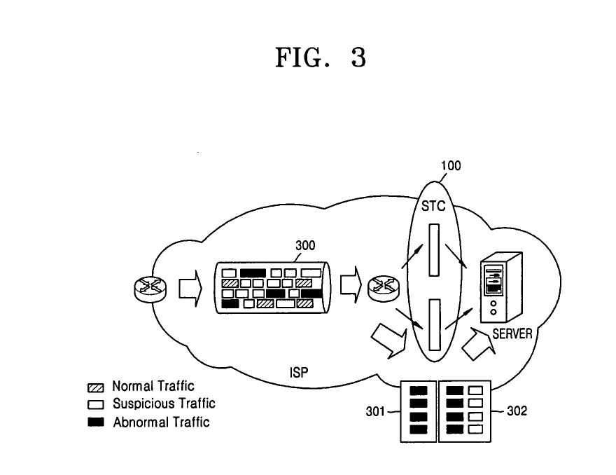

FIG. 3 is a diagram of an internet service provider (ISP) to which the method of securing the internet server is applied according to an embodiment of the present invention. Table 1 shows a policy used to limit packet traffic by the rate limiter 120. Referring to FIG. 3, when the internet server functions normally, abnormal packet traffic 301 is removed, and normal and suspicious packet traffic that respectively occupies 70% and 30% of the total bandwidth is transferred to the internet server. When the internet server fails, normal packet traffic is passed, and abnormal and suspicious packet traffic is removed by the rate limiter 120. The flow analyzer 113 analyzes all of the packets and catches the failure cause. A packet traffic limiting policy may be different from the policy shown in Table 1. Table 1 shows an example policy that changes the traffic bandwidth according to the packet classification.

TABLE 1

| Failure State | | |
|---|---|---|
| Packet Classification | Normal State (j) | Failure State (k) |
| Normal | 70% (e.g. 70 Mb/s) | 100% (e.g. 100 Mb/s) |
| Suspicious | 30% (e.g. 30 Mb/s) | 0% (e.g. 0 Mb/s) |
| Abnormal | 0% (e.g. 0 Mb/s) | 0% (e.g. 0 Mb/s) |

It is possible for the present invention to be realized on a computer-readable recording medium as a computer-readable code. Computer-readable recording mediums include every kind of recording device that stores computer system-readable data. ROM, RAM, CD-ROMs, magnetic tape, floppy discs, optical data storage, etc. can be used as computer-readable recording media. The computer-readable recording medium can also be realized in the form of a carrier wave (e.g., transmission through internet). A computer-readable recording medium can be dispersed in a network-connected computer system, resulting in being stored and executed as a computer-readable code by a dispersion method. It is also possible for a font ROM data structure of the present invention to be realized on a computer-readable recording medium as computer-readable code. ROM, RAM, CD-ROMs, magnetic tape, floppy discs, optical data storage, etc. can be used as computer-readable recording media.

The apparatus and the method for securing the internet server, that are applied to a main server that provides internet service, by preventing external attacks, intrusion, or vulnerability before the internet server fails, and continuously providing normal internet service through prompt recovery when the internet server does fail, in order to guarantee reliable internet service.

The basic packet checker removes the failure cause before the internet server fails, and recovers the internet server to provide normal internet service by analyzing the packet flow when the internet server fails.

Both while the internet server functions normally as well as when it fails, internet service is continuously provided by classifying internet service users and limiting bandwidth allocated to the packets.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the present invention is defined not by the detailed description of the invention but by the appended claims, and all differences within the scope of the present invention will be construed as being included in the present invention.

What is claimed is:

1. An apparatus for securing an internet server, comprising:
a conformance determiner which determines whether or not packets received from a network are normal, and outputs a determination result;
a rate limiter which classifies packets according to predetermined rates, and limits bandwidth; and
a server global information base which contains basic information including user information and site information, and is used to determine whether or not a packet is normal, and provides basic information to the conformance determiner and the rate limiter.

2. The apparatus of claim 1, wherein the conformance determiner comprises:
a basic packet checker which analyzes packets received from the network based on the user information and site information, and outputs analysis information; and
a flow analyzer which passes normal packets, and analyzing a failure cause of abnormal packets, when the internet server fails.

3. The apparatus of claim 2, wherein the flow analyzer is alternatively operated when the internet server fails since the basic packet checker does not deal with a network failure, separates black packets and white packets, and applies packet information to the server global information base.

4. The apparatus of claim 1, wherein the rate limiter comprises:
a classifier which classifies packets according to three rates of normal, suspicious, and abnormal based on the determination result; and
a controller which controls the bandwidth of packets having classified rates.

5. The apparatus of claim 1, wherein the server global information base has detailed user information including black and white lists relating to users' IP addresses and user variation per time period as the basic information.

6. The apparatus of claim 1, further comprising:
a dynamic platform which dynamically applies a new function and a policy of an external device to the apparatus while the apparatus operates.

7. A method of securing an internet server, comprising:
preparing basic information including user information and site information used to determine whether or not a packet is normal;
receiving packets from a network, and determining whether or not the packets are normal; and
classifying the packets according to rates, and limiting bandwidth according to the rates.

8. The method of claim 7, wherein receiving the packets comprises:
checking whether or not received packets are normal based on the user information and site information; and
passing normal packets, and analyzing a failure cause of abnormal packets when the internet server fails.

9. The method of claim 8, wherein passing the normal packets comprises collecting packets, creating a packet flow, and analyzing the failure cause.

10. The method of claim 7, wherein the packets are classified into three rates of normal, suspicious, and abnormal, and the bandwidth is limited according to the three rates.

11. A computer readable medium having embodied thereon a computer program for executing a method, comprising:
preparing basic information including user information and site information used to determine whether or not a packet is normal;
receiving packets from a network, and determining whether or not the packets are normal; and
classifying the packets according to rates, and limiting bandwidth according to the rates.
